(19) United States
(12) Patent Application Publication
(10) Pub. No.: US 2024/0304376 A1
(43) Pub. Date: Sep. 12, 2024

(54) COIL COMPONENT

(71) Applicant: SAMSUNG ELECTRO-MECHANICS CO., LTD., Suwon-si (KR)

(72) Inventors: Byeong Cheol MOON, Suwon-si (KR); In Young KANG, Suwon-si (KR); Seok Hwan AHN, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/375,310

(22) Filed: Sep. 29, 2023

(30) Foreign Application Priority Data
Mar. 8, 2023 (KR) 10-2023-0030737

(51) Int. Cl. H01F 27/29

(52) U.S. Cl. CPC H01F 27/292

(57) ABSTRACT

A coil component includes a body having a recess formed therein, a support member disposed within the body, a coil disposed on the support member, and an external electrode disposed on one surface of the body, the external electrode extending to the recess to be connected to the coil. The external electrode includes a first metal layer disposed on the recess to be in contact with the coil, and a conductive resin layer having at least a portion in contact with the first metal layer.

### CROSS-REFERENCE TO RELATED APPLICATION(S)

This application claims benefit of priority to Korean Patent Application No. 10-2023-0030737 filed on Mar. 8, 2023 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with a resistor and a capacitor.

As electronic devices are designed to have higher performance and a reduced size, electronic components used in electronic devices have been increased in number and reduced in size.

It is advantageous to arrange a coil component for integration only on a mounting surface, such that an external electrode is exposed. There is a demand for a coil component including an external electrode including a ductile material to enhance mechanical properties and breakdown voltage (BDV) to withstand vibrations or impacts.

### RELATED ART DOCUMENT

### [Patent Document]

Patent Document 1: KR Patent Application Publication No. 10-2020-0041696

### SUMMARY

An aspect of the present disclosure is to provide a coil component including an external electrode including a metallic resin layer, thereby having improved mechanical properties capable of withstanding vibrations or impacts.

Another aspect of the present disclosure is to reduce occurrence of acoustic noise due to magnetostriction of a coil component.

Another aspect of the present disclosure is to increase breakdown voltage (BDV) of a coil component.

According to an aspect of the present disclosure, there is provided a coil component including a body having a recess formed therein, a support member disposed within the body, a coil disposed on the support member, and an external electrode disposed on one surface of the body, the external electrode extending to the recess to be connected to the coil. The external electrode may include a first metal layer disposed on the recess to be in contact with the coil, and a conductive resin layer having at least a portion in contact with the first metal layer.

According to an aspect of the present disclosure, a coil component may have improved mechanical properties so as to withstand vibrations or impacts.

According to another aspect of the present disclosure, the coil component may reduce occurrence of acoustic noise due to magnetostriction.

According to another aspect of the present disclosure, the coil component may have enhanced breakdown voltage (BDV) characteristics.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a coil component according to a first example embodiment of the present disclosure;

FIG. 2 is a cross-sectional view taken along line I-I′ of FIG. 1;

FIG. 3 is a cross-sectional view taken along line II-II′ of FIG. 1;

FIG. 4 illustrates a coil component according to a second example embodiment of the present disclosure, and is a view corresponding to FIG. 2;

FIG. 5 is a modification of a second example embodiment of the present disclosure, and is a view corresponding to FIG. 4;

FIG. 6 illustrates a coil component according to a third example embodiment of the present disclosure, and is a view corresponding to FIG. 2;

FIG. 7 illustrates a coil component according to a fourth example embodiment of the present disclosure, and is a view corresponding to FIG. 2;

FIG. 8 illustrates a coil component according to a fifth example embodiment of the present disclosure, and is a view corresponding to FIG. 2;

FIG. 9 illustrates a coil component according to a sixth example embodiment of the present disclosure, and is a view corresponding to FIG. 6;

FIG. 10 illustrates a coil component according to a seventh example embodiment of the present disclosure, and is a view corresponding to FIG. 8;

FIG. 11 illustrates a coil component according to an eighth example embodiment of the present disclosure, and is a view corresponding to FIG. 9; and

FIG. 12 illustrates a coil component according to a ninth example embodiment of the present disclosure, and is a view corresponding to FIG. 7.

### DETAILED DESCRIPTION

The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean the element is positioned on or below a target portion, and does not necessarily mean that the element is positioned on an upper side of the target portion with respect to a direction of gravity.

The terms “coupled to,” “connected to,” and the like, may not only indicate that elements are directly and physically in contact with each other, but also include a configuration in which the other element is interposed between the elements such that the elements are also in contact with the other component.

The size and thickness of each element illustrated in the drawings is arbitrarily represented for ease of description, but the present disclosure is not necessarily limited to those illustrated herein.

In the drawings, an L direction may be defined as a first direction or a length direction, a W direction may be defined as a second direction or a width direction, and a T direction may be defined as a third direction or a thickness direction.

Hereinafter, a coil component according to an example embodiment of the present disclosure will be described in detail with reference to the accompanying drawings, and in the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high-frequency (HF) inductor, a general bead, a high-frequency bead (GHz bead), a common mode filter, or the like.

### First Example Embodiment

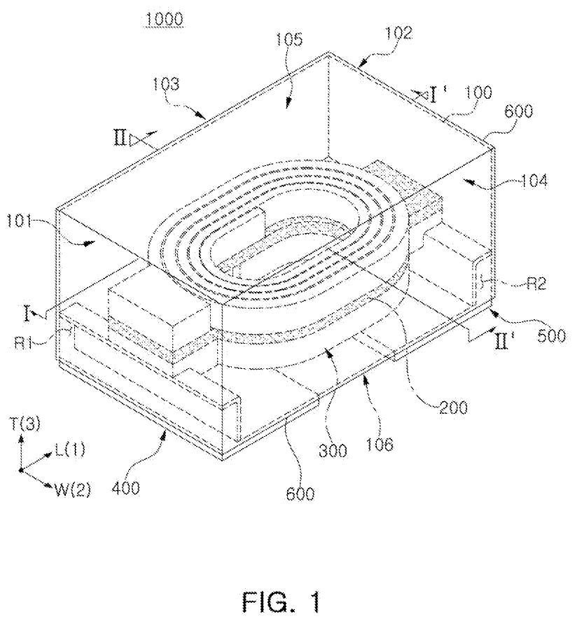

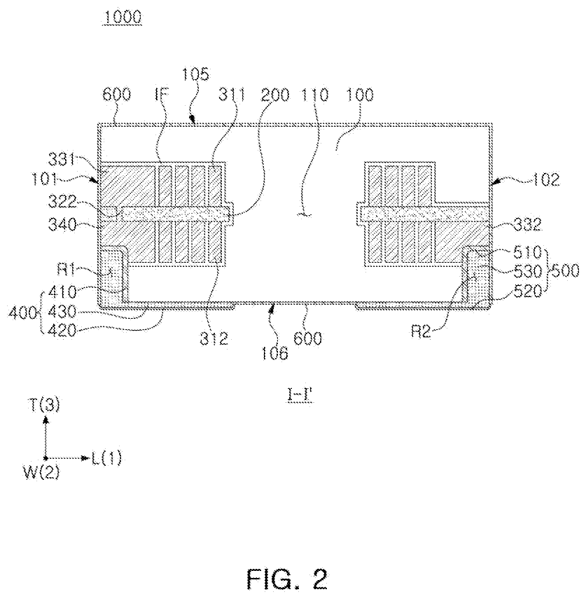

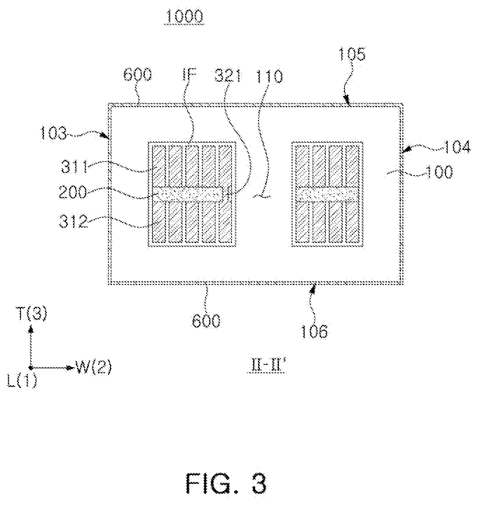

FIG. 1 is a schematic perspective view of a coil component 1000 according to a first example embodiment of the present disclosure. FIG. 2 is a cross-sectional view a taken along line I-I′ in FIG. 1. FIG. 3 is a cross-sectional view taken along line II-II′ of FIG. 1.

Referring to FIGS. 1 to 3, the coil component 1000 according to the first example embodiment of the present disclosure may include a body 100, a support member 200, a coil 300, and external electrodes 400 and 500, and may further include an insulating layer 600 covering the body 100.

In the coil component 1000 according to the present example embodiment, the external electrodes 400 and 500 may include conductive resin layers 430 and 530 having ductility, thereby improving mechanical properties capable of withstanding vibrations or impacts and reducing the occurrence of acoustic noise due to magnetostriction. In addition, first metal layers 410 and 510 may be pre-plated on a portion of the external electrodes 400 and 500 on the recesses R1 and R2 in direct contact with the coil 300 to improve connection reliability with the coil 300, and improve R_{dc} characteristics.

Hereinafter, main elements included in the coil component 1000 according to the present example embodiment will be described in detail.

The body 100 may form the exterior of the coil component 1000 according to the present example embodiment, and may include the support member 200 and the coil 300 buried therein.

The body 100 may have an overall hexahedral shape.

The body 100 may have a first surface and a second surface opposing each other in a length direction L (first direction), a third surface 103 and a fourth surface 104 opposing each other in a width direction W (second direction), and a fifth surface 105 and a sixth surface 106 opposing each other in a thickness direction T (third direction). Each of the first to fourth surfaces of the body 100 may be a wall surface of the body 100 connecting, to each other, the fifth surface and the sixth surface of the body 100. Hereinafter, both end surfaces of the body 100 may refer to the first surface 101 and the second surface 102 of the body 100, both side surfaces of the body 100 may refer to the third surface 103 and the fourth surface 104 of the body 100, and one surface and the other surface of the body 100 may refer to the sixth surface 106 and the fifth surface 105 of the body 100, respectively.

For example, the body 100 may be formed such that the coil component 1000 according to the present example embodiment, including the external electrodes 400 and 500 to be described below, has a length of 2.5 mm, a width of 2.0 mm, and a thickness of 1.0 mm, has a length of 2.0 mm, a width of 1.2 mm, and a thickness of 0.65 mm, has a length of 1.6 mm, a width of 0.8 mm, and a thickness of 0.8 mm, has a length of 1.0 mm, a width of 0.5 mm, and a thickness of 0.8 mm, or has a length of 0.8 mm, a width of 0.4 mm, a thickness of 0.65 mm. The above-described dimensions refer to dimensions not reflecting a process error, such that it should be considered that the dimensions are within a range admitted as a processor error.

With respect to an optical microscope or scanning electron microscope (SEM) image of a length directional (L)-thickness directional (T) cross-section of a width directional (W) central portion of the coil component 1000, the above-described length of the coil component 1000 may refer to a maximum value among dimensions of a plurality of line segments connecting, to each other, two outermost boundary lines of the coil component 1000 opposing each other in the length direction L illustrated in the image, to be parallel to the length direction L, the plurality of line segments spaced apart from each other in the thickness direction T. Alternately, the above-described length of the coil component 1000 may refer to a minimum value among the dimensions of the plurality of line segments. Alternately, the above-described length of the coil component 1000 may refer to an arithmetic mean value of at least three dimensions among the dimensions of the plurality of segments. Here, the plurality of line segments, parallel to the length direction L, may be equally spaced apart from each other in the thickness direction T, but the present disclosure is not limited thereto.

With respect to the optical microscope or SEM image of the length directional (L)-thickness directional (T) cross-section of the width directional (W) central portion of the coil component 1000, the above-described thickness of the coil component 1000 may refer to a maximum value among dimensions of a plurality of line segments connecting, to each other, two outermost boundary lines of the coil component 1000 opposing each other in the thickness direction T illustrated in the image, to be parallel to the thickness direction T, the plurality of line segments spaced apart from each other in the length direction L. Alternately, the above-described thickness of the coil component 1000 may refer to a minimum value among the dimensions of the plurality of line segments. Alternately, the above-described thickness of the coil component 1000 may refer to an arithmetic mean value of at least three dimensions among the dimensions of the plurality of segments. Here, the plurality of line segments, parallel to the thickness direction T, may be equally spaced apart from each other in the length direction L, but the present disclosure is not limited thereto.

With respect to an optical microscope or SEM image of a length directional (L)-width directional (W) cross-section of a thickness directional (W) central portion of the coil component 1000, the above-described width of the coil component 1000 may refer to a maximum value among dimensions of a plurality of line segments connecting, to each other, two outermost boundary lines of the coil component 1000 opposing each other in the width direction W illustrated in the image, to be parallel to the width direction W, the plurality of line segments spaced apart from each other in the length direction L. Alternately, the above-described width of the coil component 1000 may refer to a minimum value among the dimensions of the plurality of line segments. Alternately, the above-described width of the coil component 1000 may refer to an arithmetic mean value of at least three dimensions among the dimensions of the plurality of segments. Here, the plurality of line segments, parallel to the width direction W, may be equally spaced apart from each other in the length direction L, but the present disclosure is not limited thereto.

Alternatively, each of the length, width, and thickness of the coil component 1000 may be measured by a micrometer measurement method. Each of the length, width, and thickness of the coil component 1000 may be measured using the micrometer measurement method by setting a zero point with a gage repeatability and reproducibility (R&R) micrometer, inserting the coil component 1000 according to the present example embodiment into a tip of the micrometer, and turning a measurement lever of the micrometer. In measuring the length of the coil component 1000 using the micrometer measurement method, the length of the coil component 1000 may refer to a value measured once or an arithmetic mean of values measured multiple times, which may be applied to the width and thickness of the coil component 1000 in the same manner.

The body 100 may include a magnetic material and a resin. Specifically, the body 100 may be formed by laminating one or more magnetic composite sheets in which the magnetic material is dispersed in the resin. However, the body 100 may have a structure other than a structure in which the magnetic material is dispersed in the resin. For example, the magnetic material may be formed of a magnetic material such as ferrite.

The magnetic material may be ferrite or metal magnetic powder.

The ferrite powder may be, for example, at least one of spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, or the like, hexagonal ferrite such as Ba—Zn-based ferrite, Ba—Mg-based ferrite, Ba—Ni-based ferrite, Ba—Co-based ferrite, Ba—Ni—Co-based ferrite, or the like, garnet-type ferrite such as Y-based ferrite or the like, and Li-based ferrite.

The magnetic metal power may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal power may be at least one of pure iron powder, Fe—Si-based alloy power, Fe—Si—Al-based alloy power, Fe—Ni-based alloy power, Fe—Ni—Mo-based alloy power, Fe—Ni—Mo—Cu-based alloy power, Fe—Co-based alloy power, Fe—Ni—Co-based alloy power, Fe—Cr-based alloy power, Fe—Cr—Si-based alloy power, Fe—Si—Cu—Nb-based alloy power, Fe—Ni—Cr-based alloy power, and Fe—Cr—Al-based alloy power.

The magnetic metal powder may be amorphous or crystalline. For example, the magnetic metal powder may be Fe—Si—B—Cr-based amorphous alloy powder, but the present disclosure is not necessarily limited thereto.

The magnetic metal powder may have an average diameter of about 0.1 μm to about 30 μm, but the present disclosure is not limited thereto.

The body 100 may include two or more types of magnetic materials dispersed in the resin. Here, the different types of magnetic materials mean that the magnetic materials dispersed in the resin are distinguished from each other by one of an average diameter, a composition, crystallinity, and a shape.

The resin may include, but the present disclosure is not limited to, epoxy, polyimide, a liquid crystal polymer, or the like alone or in combination.

The body 100 may include a core 110, passing through the support member 200 and a coil 300 to be described below. The core 110 may be formed by filling a through-hole inside the support member 200 and the coil 300 with a magnetic composite sheet, but the present disclosure is not limited thereto.

Referring to FIGS. 1 and 2, recesses R1 and R2 may be formed in an edge region of the sixth surface 106 of the body 100. Specifically, a first recess R1 may be formed between the first surface 101 and the sixth surface 106 of the body, and may extend to the third surface 103 and the fourth surface 104 of the body 100 in a second direction W. In addition, a second recess R2 may be formed between the second surface 102 and the sixth surface 106 of the body 100, and may extend to the third surface 103 and the fourth surface 104 of the body 100 in the second direction W.

The recesses R1 and R2 may not extend up to the fifth surface 105 of the body 100. That is, the recesses R1 and R2 may not pass through the body 100 in a third direction T of the body 100.

The recesses R1 and R2 may be formed by performing a pre-dicing on one surface of a coil bar at a coil bar level, a state before each coil component is individuated, along a virtual boundary line corresponding to the second direction W of each coil component. In such pre-dicing, a depth of each of a second lead-out portion 332 and a sub-lead-out portion 340 to be described below may be adjusted such that the second lead-out portion 332 and the sub-lead-out portion 340 are exposed to the recesses R1 and R2, respectively.

Internal surfaces of the recesses R1 and R2 may include inner walls substantially parallel to the first and second surfaces 101 and 102 of the body 100, and a bottom surface connecting the inner walls to the first and second surfaces 101 and 102 of the body 100. However, the present disclosure is not limited thereto. For example, the internal surface of the first recess R1 may be in the form of a curve connecting, to each other, the first surface 101 and the sixth surface 106 of the body 100 on an L-T cross-section, such that the inner wall and the bottom surface described above may not be distinguished from each other, and may have an irregular shape.

The internal surfaces of the recesses R1 and R2 may also correspond to surfaces of the body 100. However, in the description set forth herein, the internal surfaces of the recesses R1 and R2 will be distinguished from the first to sixth surfaces 101, 102, 103, 104, 105, and 106, surfaces of the body 100, for ease of understanding and description of the present disclosure.

The support member 200 may be disposed within the body 100. The support member 200 may support the coil 300. Specifically, the support member 200 may support first and second coil portions 311 and 312 disposed on both surfaces thereof.

The support member 200 may be excluded in some example embodiments in which the coil 300 corresponds to a winding-type coil or has a coreless structure.

The support member 200 may include an insulating material, for example, a thermosetting insulating resin such as an epoxy resin, a thermoplastic insulating resin such as polyimide, or a photosensitive insulating resin, or the support member 200 may include an insulating material in which a reinforcing material such as a glass fiber or an inorganic filler is impregnated with the insulating resin. For example, the support member 200 may be formed of an insulating material such as prepreg, an Ajinomoto build-up film (ABF), FR-4, a bismaleimide triazine (BT) resin, a photo-imageable dielectric (PID), a copper clad laminate (CCL), or the like, but the present disclosure is not limited thereto.

The inorganic filler may be at least one selected from the group consisting of silica (SiO₂), alumina (Al₂O₃), silicon carbide (SiC), barium sulfate (BaSO₄), talc, mud, a mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃).

When the support member 200 is formed of an insulating material including a reinforcing material, the support member 200 may provide more excellent rigidity. When the support member 200 is formed of an insulating material including no glass fiber, it may be advantageous in reducing a thickness of the coil component 1000 by thinning an overall thickness (indicating a sum of dimensions of the coil 300 and the support member 200 in the third direction T of FIG. 1) of the support member 200 and the coil 300. When the support member 200 is formed of an insulating material including a photosensitive insulating resin, the number of processes for forming the coil 300 may be reduced, thereby being advantageous in reducing production costs, and forming fine vias 321 and 322. The support member 200 may have a thickness of, for example, 10 μm to 50 μm, but the present disclosure is not limited thereto.

The coil 300 may be buried in the body 100 to exhibit characteristics of the coil component 1000. For example, when the coil component 1000 according to the present example embodiment is used as a power inductor, the coil 300 may serve to stabilize power of an electronic device by storing an electric field as a magnetic field and maintaining an output voltage.

The coil 300 may include the first and second coil portions 311 and 312, the first via 321, and first and second lead-out portions 331 and 332, and may further include the sub-lead-out portion 340 and the second via 322.

Referring to FIG. 2, with respect to the direction of FIG. 2, the first coil portion 311 and the first lead-out portion 331 may be disposed on an upper surface of the support member 200, opposing the fifth surface 105 of the body 100, and the second coil portion 312, the second lead-out portion 332, and the sub-lead-out portion 340 may be disposed on a lower surface of the support member 200, opposing the sixth surface 106 of the body 100.

Referring to FIGS. 1 and 2, the first coil portion 311 may be disposed on the upper surface of the support member 200 to form a plurality of turns around the core 110, and an outermost turn may extend to be contact-connected to the first lead-out portion 331. The first coil portion 311 may have a planar spiral shape, but the present disclosure is not limited thereto, and may also have an angled shape.

The first lead-out portion 331 may be disposed on the upper surface of the support member 200 and exposed to the first surface 101 of the body 100, and may be covered with an insulating layer 600 to be described below.

The first lead-out portion 331 may be connected to the sub-lead-out portion 340 on the lower surface of the support member 200 via the second via 322. The sub-lead-out portion 340 may be disposed on the lower surface of the support member 200, and may be spaced apart from the second coil portion 312.

The sub-lead-out portion 340 may be exposed to the first surface 101 of the body 100 and the internal surface of the first recess R1 to be connected to a first external electrode 400 to be described below. In the present example embodiment, the sub lead-out portion 340 may have an asymmetrical structure in which the sub lead-out portion 340 is disposed on only one side of the body 100, but the present disclosure is not limited thereto, and may further include a sub lead-out portion exposed to the second surface 102 of the body 100. In the asymmetric structure in which the sub-lead-out portion 340 is formed only on one side of the body 100 as in the present example embodiment, the body 100 may have increased effective volume, thereby improving inductance characteristics.

The second coil portion 312 may be disposed on the lower surface of the support member 200 to form a plurality of turns around the core 110, and an outermost turn may extend to be contact-connected to the second lead-out portion 332. The second coil portion 312 may have a planar spiral shape, but the present disclosure is not limited thereto, and may also have an angled shape.

The second lead-out portion 332 may be disposed on the lower surface of the support member 200 and exposed to the second surface 102 of the body 100 and the internal surface of the second recess R2 to be connected to a second external electrode 500 to be described below.

Referring to FIG. 3, the first via 321 may connect, to each other, the first and second coil portions 311 and 312 disposed on both surfaces of the support member 200. The first via 321 may pass through the support member 200 to connect innermost turns of the first and second coil portions 311 and 312 to each other.

Accordingly, a signal, input to the first external electrode 400, may be output to a second external electrode 500 via the sub-lead-out portion 340, the second via 322, the first lead-out portion 331, the first coil portion 311, the first via 321, the second coil portion 312, and the second lead-out portion 332. Respective elements of the coil 300 may generally function as a single coil connected between the first and second external electrodes 400 and 500 via such a structure.

At least one of the first and second coil portions 311 and 312, the first and second vias 321 and 322, the first and second lead-out portions 331 and 332, and the sub-lead-out portion 340 may include one or more conductive layers. For example, when the first coil portion 311, the first lead-out portion 331, and the first via 321 are formed on the upper surface of the support member 200 by plating, each of the first coil portion 311, the first lead-out portion 331, and the first via 321 may include a first conductive layer formed by electroless plating or the like, and a second conductive layer disposed on the first conductive layer.

The first conductive layer may be a seed layer for forming the second conductive layer on the support member 200 by plating, and the second conductive layer may be an electroplating layer. Here, the electroplating layer may have a monolayer structure or a multilayer structure. The electroplating layer having a multilayer structure may be formed to have a conformal film structure in which one electroplating layer is covered by another electroplating layer, and may be formed to have a shape in which the other electroplating layer is laminated on only one surface of the one electroplating layer. A seed layer of the first coil portion 311 and a seed layer of the first lead-out portion 331 may be integrated with each other, such that no boundary may be formed therebetween, but the present disclosure is not limited thereto. An electroplating layer of the first coil portion 311 and an electroplating layer of the first lead-out portion 331 may be integrated with each other, such that no boundary may be formed therebetween, but the present disclosure is not limited thereto.

Each of the first and second coil portions 311 and 312, the first and second vias 321 and 322, the first and second lead-out portions 331 and 332, and the sub-lead-out portion 340 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

Referring to FIGS. 2 and 3, the coil component 1000 according to the present example embodiment may further include an insulating film IF within the body 100.

The insulating film IF may insulate the coil portions 311 and 312, the lead-out portions 331 and 332, and the sub-lead-out portion 340 from the body 100. The insulating layer IF may include, for example, parylene, but the present disclosure is not limited thereto. The insulating film IF may be formed by a method such as vapor deposition, but the present disclosure is not limited thereto, and may be formed by laminating insulating films on both surfaces of the support member 200. The insulating film IF may have a structure in which a portion of a plating resist, used to form the coil 300 by electroplating, is included, but the present disclosure is not limited thereto.

Referring to FIG. 2, the first and second external electrodes 400 and 500 may be disposed on one surface 106 of the body 100 to be spaced apart from each other, and may extend to the first and second recesses R1 and R2 to be connected to the sub-lead-out portion 340 and the second lead-out portion 332, respectively.

Each of the first and second external electrodes 400 and 500 may include a connection portion disposed on the recesses R1 and R2 to be connected to the sub-lead-out portion 340 or the second lead-out portion 332, and a pad portion extending from the connection portion to the sixth surface 106 of the body 100. The connection portion and the pad portion may be integrated with each other, but the present disclosure is not limited thereto.

The pad portions of the external electrodes 400 and 500 may be in contact with a connection member such as a solder or the like, when the coil component 1000 is mounted on a printed circuit board, and may be formed on the sixth surface 106 of the body 100 to protrude further than an insulating layer 600 to be described below. In a case in which the pad portions of the external electrodes 400 and 500 are formed to protrude as in the present example embodiment, when the coil component 1000 is mounted, an area of contact with a connection member such as a solder may be widened to increase adhesive strength, and a distance from a printed circuit board may also be increased to reduce the risk of short circuits.

The external electrodes 400 and 500 may be formed along the internal surfaces of the recesses R1 and R2 and the sixth surface 106 of the body 100, respectively. The external electrodes 400 and 500 may be formed to fill the recesses R1 and R2, but the present disclosure is not limited thereto. For example, the external electrodes 400 and 500 may be in the form of a film conformal to the internal surfaces of the recesses R1 and R2 and the sixth surface 106 of the body 100. In this case, the external electrodes 400 and 500 may be formed using a thin film process such as a sputtering process or a plating process.

Referring to FIG. 2, the external electrodes 400 and 500 may include the first metal layers 410 and 510 disposed on the recesses R1 and R2 to be in contact with the coil 300, and the conductive resin layers 430 and 530 disposed on one surface of the body 100, that is, the sixth surface 106 and connected to the first metal layers 410 and 510.

In addition, the external electrodes 400 and 500 may further include second metal layers 420 and 520 covering at least a portion of the conductive resin layers 430 and 530.

The first metal layers 410 and 510 may be in direct contact with both ends of the coil 300, and may correspond to first layers of the external electrodes 400 and 500 on the recesses R1 and R2.

The first metal layers 410 and 510 may include a metal the same as a metal included in the coil 300, and may correspond to a copper (Cu) pre-plating layer, for example. In the present example embodiment, the first metal layers 410 and 510 may be disposed so as not to extend up to the sixth surface 106 of the body 100, but the present disclosure is not limited thereto, and a portion of the first metal layers 410 and 510 may extend between the sixth surface 106 of the body 100 and the conductive resin layers 430 and 530.

In the present example embodiment, via the above-described structure, the conductive resin layer 430, having a relatively high resistivity, may not be in direct contact with the sub-lead-out portion 340 and the second lead-out portion 332 exposed to the recesses R1 and R2, and the first metal layers 410 and 510 may be disposed first, thereby preventing degradation of R_{dc} characteristics. In addition, the first metal layers 410 and 510 having an element the same as that of the coil 300 may be in direct contact with the coil 300, thereby improving connection reliability between the coil 300 and the external electrodes 400 and 500.

The first metal layers 410 and 510 may be formed of a conductive material such as copper (Cu), aluminum (Al), silver (Ag), tin (Sn), gold (Au), platinum (Pt), palladium (Pd), nickel (Ni), lead (Pb), chromium (Cr), titanium (Ti), or alloys thereof, but the present disclosure is not limited thereto. In particular, when the first metal layers 410 and 510 include noble metals such as silver (Ag), gold (Au), platinum (Pt), and palladium (Pd), the coil component 1000 having improved heat resistance may be implemented.

The first metal layers 410 and 510 may be formed by vapor deposition such as electroplating or sputtering, but the present disclosure is not limited thereto.

The conductive resin layers 430 and 530 may include a resin element, and the resin element may have flexibility or elasticity, and thus may have characteristics being more resistant to vibrations or impacts as compared to the metal layer. In the coil component 1000 according to the present example embodiment, the external electrodes 400 and 500 may include the conductive resin layers 430 and 530 having ductility, thereby improving mechanical properties such as earthquake resistance.

Referring to FIG. 2, at least a portion of the conductive resin layers 430 and 530 may be disposed to be in contact with the first metal layers 410 and 510.

In addition, the conductive resin layers 430 and 530 may be disposed to be in contact with one surface of the body 100, that is, the sixth surface 106. Here, when the conductive resin layers 430 and 530, disposed on the sixth surface 106 of the body 100, are mounted on a printed circuit board, a connection distance from a connection member such as a solder may be short. Thus, when the conductive resin layers 430 and 530 are directly disposed on the sixth surface 106 of the body 100 without the first metal layers 410 and 510, there may be no significant risk of degradation of R_{dc} characteristics. Conversely, the conductive resin layers 430 and 530 may be disposed to be in direct contact with the sixth surface 106 of the body 100, and thus may have an effect of enhancing bonding strength and flexibility by a combination of a resin element of the body 100 and a resin element of the conductive resin layers 430 and 530. However, the present disclosure is not limited thereto, and at least a portion of the first metal layers 410 and 510 may extend between the sixth surface 106 of the body 100 and the conductive resin layers 430 and 530.

In addition, the conductive resin layers 430 and 530 may be disposed to extend onto the first metal layers 410 and 510 disposed on the recesses R1 and R2. In this case, the conductive resin layers 430 and 530 may fill regions of the recesses R1 and R2.

A proportion occupied by the conductive resin layers 430 and 530 within the external electrodes 400 and 500 may be increased via such a structure, thereby increasing effects such as improvement in mechanical properties, reductions in acoustic noise, and the like.

The conductive resin layers 430 and 530 may include a resin and a metal element dispersed in the resin. The resin may include epoxy as a thermosetting resin. The metal element may include at least one of a silver (Ag) element or a copper (Cu) element. For example, in the present example embodiment, the conductive resin layers 430 and 530 may be Ag-Epoxy layers or Cu-Epoxy layers, but the present disclosure is not limited thereto.

The conductive resin layers 430 and 530 may be formed by applying and curing a conductive paste including conductive powder such as copper (Cu) and/or silver (Ag).

The second metal layers 420 and 520 may be disposed to cover at least a portion of the conductive resin layers 430 and 530. Specifically, the second metal layers 420 and 520 may be disposed to cover at least a portion of the conductive resin layers 430 and 530 disposed on the sixth surface 106 of the body 100. That is, when a region of the external electrodes 400 and 500, corresponding to a mounting surface, is a pad portion, a first layer of the pad portion may include the conductive resin layer 430 and 530 and a second layer of the pad portion may include the second metal layers 420 and 520.

The second metal layers 420 and 520 may include at least one of nickel (Ni) or tin (Sn). In addition, the second metal layers 420 and 520 may have a double-layer structure of a nickel (Ni) plating layer and a tin (Sn) plating layer.

When the second metal layers 420 and 520 have a double-layer structure of a nickel (Ni) plating layer and a tin (Sn) plating layer, one or more elements among a tin (Sn) element and a nickel (Ni) element of the second metal layers 420 and 520, and a silver (Ag) element and/or a copper (Cu) element in the conductive resin layers 430 and 530 may form an intermetallic compound (IMC), thereby effectively preventing a solder or a tin (Sn) element in the second metal layers 420 and 520 from permeating toward the body 100 during mounting to degrade the coil component 1000.

The second metal layers 420 and 520 may be formed by electroplating, but the present disclosure is not limited thereto.

The coil component 1000 according to the present example embodiment may further include an insulating layer 600 covering the body 100 and the external electrodes 400 and 500, the insulating layer 600 exposing at least a portion of a region of the external electrodes 400 and 500 disposed on one surface of the body 100, that is, the sixth surface 106.

Referring to FIGS. 1 to 3, the insulating layer 600 may cover the first to fifth surfaces 101, 102, 103, 104, and 105 of the body 100, and may be disposed to cover the conductive resin layers 430 and 530 disposed on the recesses R1 and R2.

Referring to FIG. 2, the insulating layer 600 may be disposed to expose a mounted region of the external electrodes 400 and 500 while covering the sixth surface 106 of the body 100, and accordingly, external surfaces of the second metal layers 420 and 520, disposed on an outermost side of the pad portion, may be exposed.

The insulating layer 600 according to the present example embodiment may be disposed on the sixth surface 106 of the body 100 to have a thickness less than that of each of the external electrodes 400 and 500. In this case, the external electrodes 400 and 500 may be formed to protrude to the mounting surface. That is, external surfaces of the second metal layers 420 and 520 may protrude further than an external surface of the insulating layer 600.

Thus, in a case in which the external electrodes 400 and 500 are disposed to protrude further than the insulating layer 600, when the coil component 1000 is mounted, an area of contact with a connection member such as a solder may be widened to increase adhesive strength, and a distance from a printed circuit board may also be increased to reduce the risk of short circuits.

The insulating layer 600 may be formed, for example, by applying and curing an insulating material including an insulating resin to a surface of the body 100. In this case, the insulating layer 600 may include at least one of a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, and a photosensitive insulating resin.

### Second Example Embodiment and Modification Thereof

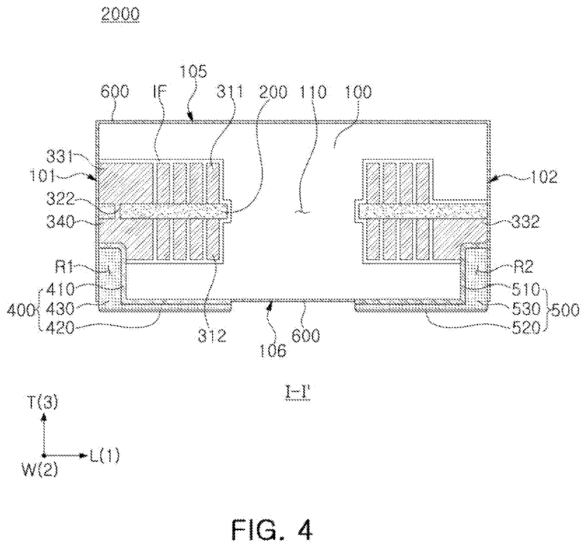

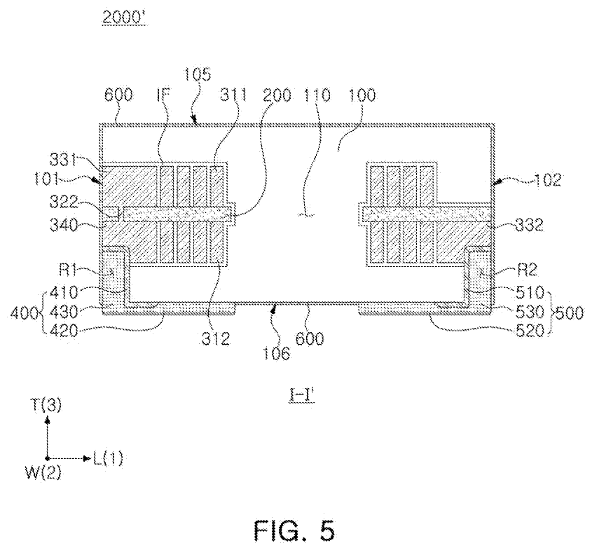

FIG. 4 illustrates a coil component 2000 according to a second example embodiment of the present disclosure, and is a view corresponding to FIG. 2. FIG. 5 is a coil component 2000′ according to a modification of the second example embodiment of the present disclosure, and is a view corresponding to FIG. 4.

Comparing FIGS. 4 and 5 to FIG. 2, an arrangement of first metal layers 410 and 510 on a sixth surface 106 of a body 100 may be different from that of the first metal layers 410 and 510 illustrated in FIG. 2.

Accordingly, in describing the present example embodiment and a modification thereof, only the arrangement of the first metal layers 410 and 510 on the sixth surface 106 of the body 100, different from that in the first example embodiment of the present disclosure, will be described. The description of the first example embodiment of the present disclosure may be applied to remaining elements of the present example embodiment in the same manner.

Referring to FIG. 4, in the coil component 2000 according to the present example embodiment, at least a portion of the first metal layers 410 and 510 may be disposed to extend between the sixth surface 106 of the body 100 and conductive resin layers 430 and 530. That is, the conductive resin layers 430 and 530 may not be directly disposed on the sixth surface 106 of the body 100, but the first metal layers 410 and 510 disposed on recesses R1 and R2 may be disposed to extend to the sixth surface 106 of the body 100, and then the conductive resin layers 430 and 530 may be disposed on the first metal layers 410 and 510.

Accordingly, the first metal layers 410 and 510 may be integrated with each other on the recesses R1 and R2 and the sixth surface 106 of the body 100.

In the coil component 2000 according to the present example embodiment, a proportion occupied by the first metal layers 410 and 510 having high conductivity in external electrodes 400 and 500 may be increased, such that a resistance element R_{dc} may be reduced.

Referring to FIG. 5, only a portion of first metal layers 410 and 510 of a coil component 2000′ according to the present modification may extend between a sixth surface 106 of a body 100 and conductive resin layers 430 and 530. That is, the first metal layers 410 and 510, partially extending to the sixth surface 106 of the body 100, and the conductive resin layers 430 and 530 may be disposed to cover a portion of the sixth side 106 of the body 100.

In the coil component 2000′ according to the present modification, a region in which the conductive resin layers 430 and 530 including a resin element are in direct contact with the body 100 also including a resin element may be widened, thereby improving bonding strength between external electrodes 400 and 500 and the body 100.

### Third Example Embodiment

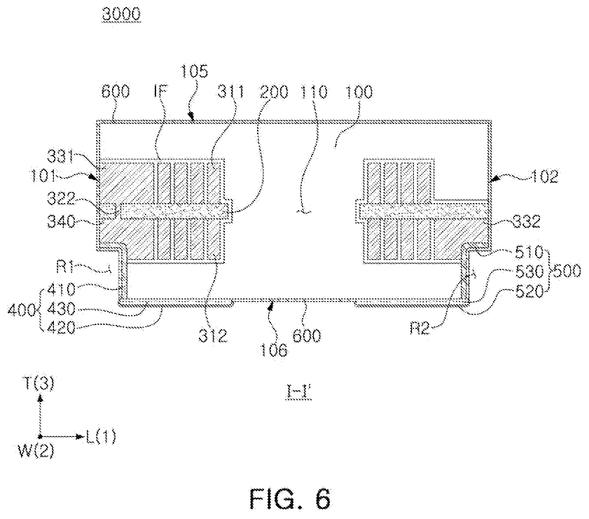

FIG. 6 illustrates a coil component 3000 according to a third example embodiment of the present disclosure, and is a view corresponding to FIG. 2.

Referring to FIG. 6, an arrangement of conductive resin layers 430 and 530 and an overall shape of the coil component 3000 according to the arrangement may be different from those in the first example embodiment.

Accordingly, in describing the present example embodiment, only the arrangement of the conductive resin layers 430 and 530 and the overall shape of the coil component 3000 according to the arrangement, different from those in the first example embodiment of the present disclosure, will be described. The description of the first example embodiment of the present disclosure may be applied to remaining elements of the present example embodiment in the same manner.

Referring to FIG. 6, the conductive resin layers 430 and 530 may be disposed only on a sixth surface 106 of a body 100 without extending to regions of recesses R1 and R2. Accordingly, a connection portion, a region disposed on the recesses R1 and R2 of external electrodes 400 and 500, may have a monolayer structure including only first metal layers 410 and 510, and an insulating layer 600 may be directly disposed on the first metal layers 410 and 510.

In the present example embodiment, a coil 300 and the conductive resin layers 430 and 530 may be electrically connected to each other via the first metal layers 410 and 510.

In the present example embodiment, the insulating layer 600, disposed in the regions of the recesses R1 and R2, may be formed along shapes of the first metal layers 410 and 510, and may be formed along shapes of the first metal layers 410 and 510, and the recesses R1 and R2 may appear in the exterior of the coil component 3000.

In the coil component 3000 according to the present example embodiment, an area of the external electrodes 400 and 500 exposed to a mounting surface may be smaller than that in the first example embodiment, and a margin may be generated in a first direction L. Accordingly, during mounting, the risk of short circuits with adjacent components may be reduced, which may be advantageous for integration.

In addition, in the present example embodiment, before dicing into individual components is performed, a process of performing pre-dicing for forming the recesses R1 and R2 in a coil bar state, and then filling a slit with the conductive resin layers 430 and 530 may be omitted, thereby increasing production efficiency.

### Fourth Example Embodiment

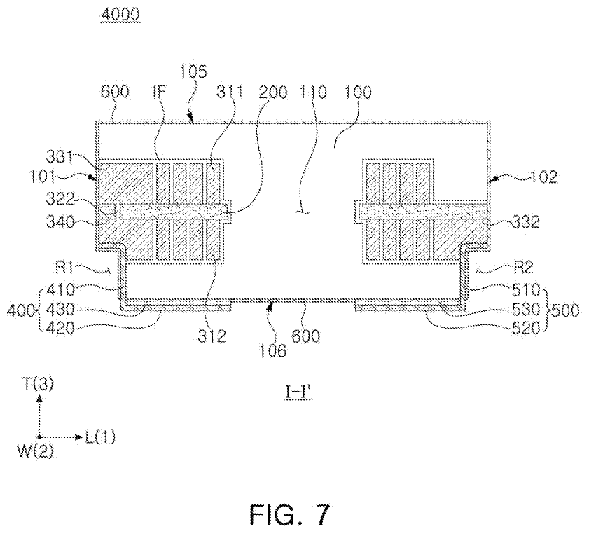

FIG. 7 illustrates a coil component 4000 according to a fourth example embodiment of the present disclosure, and is a view corresponding to FIG. 6.

Comparing FIG. 7 to FIG. 6, an arrangement relationship between first metal layers 410 and 510, second metal layers 420 and 520, and conductive resin layers 430 and 530 may be different from that illustrated in FIG. 6.

Accordingly, in describing the present example embodiment, only the arrangement relationship between the first metal layers 410 and 510, the second metal layers 420 and 520, and the conductive resin layers 430 and 530, different from that in the third example embodiment of the present disclosure, will be described, and the description of the third example embodiment of the present disclosure may be applied to remaining elements of the present example embodiment in the same manner.

Referring to FIG. 7, in the coil component 4000 according to the present example embodiment, the conductive resin layers 430 and 530 may be first disposed on a sixth surface 106 of a body 100, and then the first metal layers 410 and 510 may be disposed to cover recesses R1 and R2 and the conductive resin layers 430 and 530.

In addition, the second metal layers 420 and 520 may be directly disposed on the first metal layers 410 and 510.

That is, in external electrodes 400 and 500 of the coil component 4000 according to the present example embodiment, a region disposed on the recesses R1 and R2 and connected to a coil 300 may have a monolayer structure including only the first metal layers 410 and 510, and a region disposed on the sixth surface 106 of the body 100, a mounting surface, may have a triple-layer structure including the conductive resin layers 430 and 530, the first metal layers 410 and 510, and the second metal layers 420 and 520.

In the present example embodiment, the conductive resin layers 430 and 530 may be in direct contact with the sixth surface 106 of the body 100, thereby improving bonding strength between the external electrodes 400 and 500 and the body 100 due to bonding between respective resin elements.

In addition, a step between the insulating layer 600 on the mounting surface of the body 100, that is, the sixth surface 106, and the external electrodes 400 and 500 may increase, thereby reducing defects in which movement such as rotation of the coil component 4000 occurs when the coil component 4000 is mounted on a printed circuit board via a connection member such as a solder.

In addition, the second metal layers 420 and 520 may be directly disposed on the first metal layers 410 and 510, thereby further facilitating a plating process for forming the second metal layers 420 and 520.

### Fifth and Sixth Example Embodiments

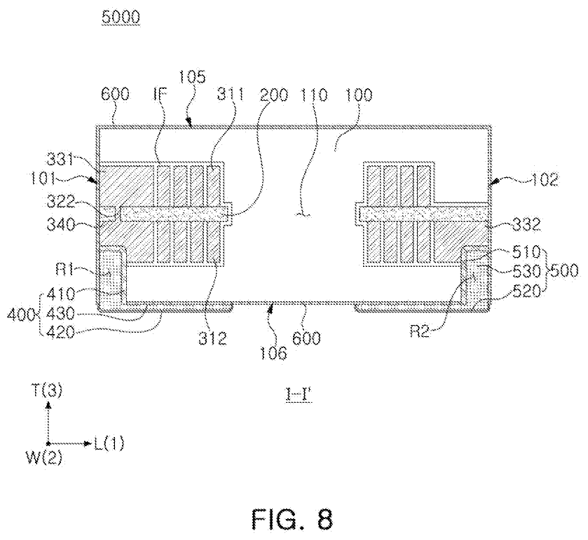

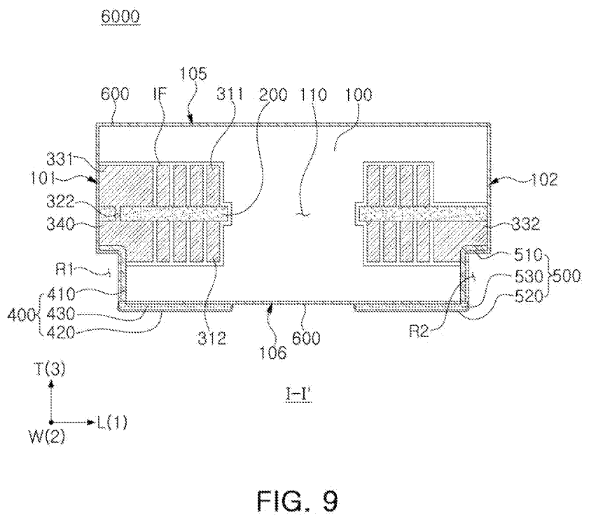

FIG. 8 illustrates a coil component 5000 according to a fifth example embodiment of the present disclosure, and is a view corresponding to FIG. 2. FIG. 9 illustrates a coil component 6000 according to a sixth example embodiment of the present disclosure, and is a view corresponding to FIG. 6.

Comparing FIG. 8 to FIG. 2 and FIG. 9 to FIG. 6, in the coil components 5000 and 6000 according to the present example embodiments, an arrangement of an insulating layer 600 on a sixth surface 106 of the body 100 may be different from those in first and third example embodiments.

Accordingly, in describing the present example embodiments, only the arrangement of the insulating layer 600 on the sixth surface 106 of the body 100, different from those in the first and third example embodiments of the present disclosure, will be described. The descriptions of the first and third example embodiments of the present disclosure may be applied to remaining elements of the present example embodiments in the same manner.

Referring to FIGS. 8 and 9, the insulating layer 600 may be disposed to extend between one surface of the body 100, that is, a sixth surface 106, and external electrodes 400 and 500.

Specifically, the insulating layer 600 may be disposed to extend between the sixth surface 106 of the body 100 and conductive resin layers 430 and 530. The insulating layer 600 may be disposed to entirely cover the sixth surface 106 of the body 100, but the present disclosure is not limited thereto. An extended region may be adjusted, as necessary. In particular, in the present example embodiments, first layers of the external electrodes 400 and 500, disposed on the sixth surface 106 of the body 100, may correspond to the conductive resin layer 430 and 530, such that the external electrodes 400 and 500 may be more easily disposed on the insulating layer 600, as compared to a case in which the first layers are metal layers.

In order to increase breakdown voltage (BDV) of a coil component, leakage current may need to be reduced via the body 100. A region in which leakage current is likely to occur may be a region corresponding to the sixth surface 106 of the body 100 in which the external electrodes 400 and 500 have a narrowest distance therebetween, thereby reducing leakage current between the external electrodes 400 and 500 via a structure in which the insulating layer 600 extends between the body 100 and the conductive resin layers 430 and 530.

That is, in the first or third example embodiment, a shortest current leakage path between the external electrodes 400 and 500 may be a distance between pad portions disposed on the sixth surface 106 of the body 100.

Conversely, when the insulating layer 600 is disposed to extend as in the present example embodiments, the shortest current leakage path between the external electrodes 400 and 500 may be a distance between connection portions disposed on the recesses R1 and R2, such that current leakage may be reduced via the body 100. As a result, a coil component may have improved withstand voltage.

### Seventh to Ninth Example Embodiments

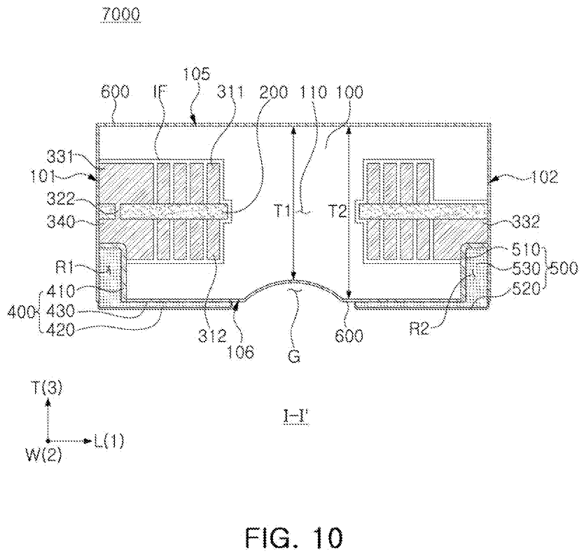

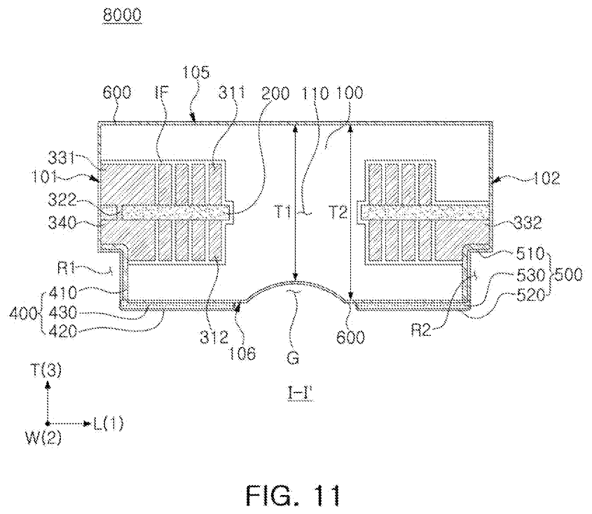

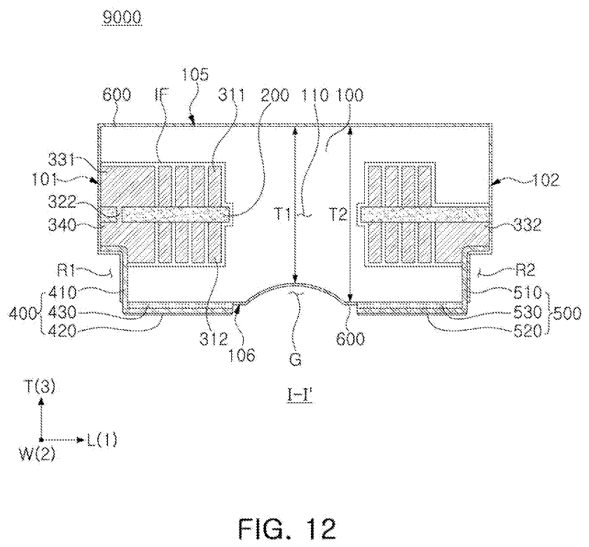

FIG. 10 illustrates a coil component 7000 according to a seventh example embodiment of the present disclosure, and is a view corresponding to FIG. 8. FIG. 11 illustrates a coil component 8000 according to an eighth example embodiment of the present disclosure, and is a view corresponding to FIG. 9. FIG. 12 illustrates a coil component 9000 according to a ninth example embodiment of the present disclosure, and is a view corresponding to FIG. 7.

Comparing FIG. 10 to FIG. 8, FIG. 11 to FIG. 9, and FIG. 12 to FIG. 7, the coil components 7000, 8000, and 9000 according to the present example embodiments may be different from those in the fourth to sixth example embodiments in that a groove G is formed on a sixth surface 106 of a body 100.

Accordingly, in describing the present example embodiments, only the groove G formed on the sixth surface 106 of the body 100, different from those in the fourth to sixth example embodiments of the present disclosure, will be described. The descriptions of the fourth to sixth example embodiments of the present disclosure may be applied to remaining elements of the present example embodiment in the same manner.

Referring to FIGS. 10 to 12, the coil components 7000, 8000, and 9000 according to the present example embodiments may further include the groove G formed on one surface of the body 100, that is, the sixth surface 106 in a region between first and second external electrodes 400 and 500.

The groove G, concave inward from a central region of the sixth surface 106 of the body 100, may be formed in a second direction W, such that a distance between a fifth surface 105 and the sixth surface 106 of the body 100 may be formed to be narrowest in a central region of the groove G.

Specifically, referring to FIGS. 10 to 12, a distance T1 between the fifth surface 105 and the sixth surface 106 of the body 100 in the central region of the groove G may be formed to be narrower than a distance T2 between the fifth surface 105 and the sixth surface 106 of the body 100 in other regions. Here, a distance between the fifth surface 105 and the sixth surface 106 of the body 100 may be a value measured in the same manner as the method of measuring a thickness of the coil component described above. Other methods and/or tools appreciated by one of ordinary skill in the art, even if not described in the present disclosure, may also be used.

The groove G may be formed on the sixth surface 106 of the body 100 using a dicing blade or a laser, or may be formed using a mold during compression and curing.

In present example embodiment, the groove G may have an arcuate cross-section curved inward, but the present disclosure is not limited thereto, and may be formed to have various shapes such as a triangular shape, a rectangular shape, a taper shape, and the like according to a shape of the dicing blade or the mold.

When the groove G is formed on the sixth surface 106 of the body 100 in the region between the external electrodes 400 and 500 as in the present example embodiments, a path of leakage current flowing through the body 100 between the external electrodes 400 and 500 may be longer, as compared to fourth to sixth example embodiments, thereby further increasing an effect of reducing leakage current and improving withstand voltage.

In addition, when the coil components 7000, 8000, and 9000 according to the present example embodiments are mounted on a printed circuit board, a distance between the printed circuit board and the coil components 7000, 8000, and 9000 may be further increased by the groove G.

Accordingly, the risk of short circuits between the external electrodes 400 and 500 may be reduced, thereby reducing external influence on a magnetic flux flowing around a coil 300.

In addition, when the coil components 5000 and 6000 are mounted, a space in which a connection member such as a solder is to be disposed may be secured by the groove G, thereby increasing adhesive strength and preventing defects due to rotation of the coil components 7000, 8000 and 9000.

While example embodiments have been illustrated and described above, it will be apparent to those skilled in the art that modifications and variations could be made without departing from the scope of the present disclosure as defined by the appended claims.

What is claimed is:

1. A coil component comprising:
a body having a recess;
a support member disposed within the body;
a coil disposed on the support member; and
an external electrode disposed on one surface of the body, the external electrode extending to the recess to be connected to the coil,
wherein the external electrode includes a first metal layer disposed on the recess to be in contact with the coil, and a conductive resin layer having at least a portion in contact with the first metal layer.

2. The coil component of claim 1, wherein at least a portion of the first metal layer extends between the one surface of the body and the conductive resin layer.

3. The coil component of claim 2, wherein the external electrode further includes a second metal layer covering at least a portion of the conductive resin layer.

4. The coil component of claim 1, wherein the conductive resin layer is disposed on the one surface of the body, and at least a portion of the first metal layer extends onto the conductive resin layer.

5. The coil component of claim 4, wherein the external electrode further includes a second metal layer covering at least a portion of the first metal layer.

6. The coil component of claim 1, wherein the conductive resin layer extends onto the first metal layer disposed on the recess.

7. The coil component of claim 1, wherein the conductive resin layer is in contact with the one surface of the body.

8. The coil component of claim 1, wherein the conductive resin layer includes a resin and a metal dispersed within the resin.

9. The coil component of claim 8, wherein the resin is a thermosetting resin, and the metal includes at least one of silver (Ag) or copper (Cu).

10. The coil component of claim 1, wherein the first metal layer includes a metal that is the same as a metal included in the coil.

11. The coil component of claim 1, wherein the first metal layer includes at least one of copper (Cu), aluminum (Al), silver (Ag), tin (Sn), gold (Au), platinum (Pt), palladium (Pd), nickel (Ni), lead (Pb), chromium (Cr), and titanium (Ti).

12. The coil component of claim 3, wherein the second metal layer includes at least one of nickel (Ni) or tin (Sn).

13. The coil component of claim 5, wherein the second metal layer includes at least one of nickel (Ni) or tin (Sn).

14. The coil component of claim 1, further comprising:
an insulating layer covering at least a portion of the body and the external electrode, the insulating layer exposing at least a portion of a region of the external electrode disposed on the one surface of the body,
wherein the insulating layer extends between the one surface of the body and the external electrode.

15. The coil component of claim 14, wherein the external electrode protrudes further from the one surface than the insulating layer.

16. The coil component of claim 1, wherein
the external electrode includes first and second external electrodes disposed on the one surface of the body to be spaced apart from each other, and
the one surface of the body includes a groove in a region between the first and second external electrodes.

17. The coil component of claim 4, wherein
the external electrode includes first and second external electrodes disposed on the one surface of the body to be spaced apart from each other, and
the one surface of the body includes a groove in a region between the first and second external electrodes.

18. The coil component of claim 16, wherein
the body further has an other surface opposing the one surface, and
a distance between the one surface and the other surface is narrowest in a central region of the groove.

19. The coil component of claim 1, wherein the first metal layer extends continuously from the coil to along the one surface of the body.

20. The coil component of claim 19, wherein the one surface of the body includes a groove.

21. The coil component of claim 20, wherein
the body further has an other surface opposing the one surface, and
a distance between the one surface and the other surface is narrowest in a central region of the groove.
